(19) United States
(12) Patent Application Publication
(10) Pub. No.: US 2025/0299060 A1
(43) Pub. Date: Sep. 25, 2025

(54) APPARATUS AND METHOD OF IMITATION LEARNING

(71) Applicant: Sony Interactive Entertainment Inc., Tokyo (JP)

(72) Inventors: Timothy Bradley, London (GB); Ryan John Spick, London (GB); Adrian Barahona Rios, London (GB); Pierluigi Vito Amadori, London (GB); Ayush Raina, San Mateo, CA (US)

(73) Assignee: Sony Interactive Entertainment Inc., Tokyo (JP)

(21) Appl. No.: 19/078,855

(22) Filed: Mar. 13, 2025

(30) Foreign Application Priority Data
Mar. 22, 2024 (GB) 2404109.7

(51) Int. Cl. G06N 3/092; A63F 13/67; G06N 3/0455

(52) U.S. Cl. CPC G06N 3/092; A63F 13/67; G06N 3/0455

(57) ABSTRACT

A method of generating a training system comprising, for a set of states and corresponding actions, training separate auto encoders; using interim encoded representations from each trained auto encoder as input to a machine learning recoder, wherein each recoder is trained with a respective multi-part loss function that discriminates output representations for different respective inputs within each recoder whilst converging representations for parallel current state and action inputs between the recoders. Generating a trained imitation learning system comprises, for a set of states and corresponding actions, obtaining a proposed action for a state from the imitation learning system; inputting the action to a training system generated according to the method; obtaining the output representation of the action from the generated training system; estimating the difference between the output representation and corresponding representation of the state; and implementing a loss function for the imitation learning system based on the estimated difference.

### BACKGROUND

### Field of the Invention

The present invention relates to an apparatus and method of imitation learning.

### Description of the Prior Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly nor impliedly admitted as prior art against the present invention.

Imitation learning (IL) is similar to reinforcement learning in that both seek to train a machine learning agent to select the most appropriate actions and/or policies in response to a current state of an environment (which may be real or virtual). However, unlike reinforcement learning, IL does not use a reward function to motivate action/policy selection by the agent. Rather, IL provides the agent with a training dataset that comprises not only environment states but also the most appropriate (or at least the desired) action/policy to take in response to such environment states, these actions/policies being for example enacted by an element situated within the environment (a character/avatar in a movie, video game, or the like).

When this training dataset is provided to an IL agent, the IL agent learns to imitate the actions/policies carried out by the element and also learns the context (environment states) in which the actions/policies were carried out so that when the same context arises in the subsequent utilization of the trained IL agent, the agent may carry out the actions/policies that it has learnt to imitate, and thus respond to the context in the most appropriate/desired manner.

One issue with the performance of the IL agent is that, because it learns to match input environment states to corresponding target actions, it can be fairly inflexible with how it responds to similar environment states and generalizes actions quite poorly. Whilst one solution may be to expose the IL agent to a large number of similar environment states and corresponding actions, this is both onerous in terms of gathering appropriate training data and also requires a larger IL agent to model the different but similar state-action correspondences. This can make the IL agent too computationally expensive to use in many scenarios, including for example within a videogame console where any additional computational overhead comes at a cost to frame rate and/or graphical quality.

The present invention seeks to alleviate or mitigate this issue.

### SUMMARY OF THE INVENTION

Various aspects and features of the present invention are defined in the appended claims and within the text of the accompanying description.
In a first aspect, a method of generating a training system is provided in accordance with claim 1.
In another aspect, a method of generating a trained imitation learning system is provided in accordance with claim 5.
In another aspect, a method of automatically generating an action in response to an input state is provided in accordance with claim 8.
In another aspect, a training system generator is provided in accordance with claim 12.
In another aspect, an imitation learning system generator is provided in accordance with claim 13.
In another aspect, an action generator is provided in accordance with claim 14.
In another aspect, an entertainment device is provided in accordance with claim 15.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 is a schematic diagram of an autoencoder in accordance with embodiments of the present description.

FIG. 2 is a schematic diagram of a training system generator in accordance with embodiments of the present description.

FIG. 3 is a flow diagram of a method of generating a training system in accordance with embodiments of the present description.

FIG. 4 is a flow diagram of a method of generating a trained imitation learning system in accordance with embodiments of the present description.

FIG. 5 is a flow diagram of a method of automatically generating an action in response to an input state in accordance with embodiments of the present description.

FIG. 6 is a schematic diagram of an entertainment device in accordance with embodiments of the present description.

### DESCRIPTION OF THE EMBODIMENTS

An apparatus and method of imitation learning are disclosed. In the following description, a number of specific details are presented in order to provide a thorough understanding of the embodiments of the present invention. It will be apparent, however, to a person skilled in the art that these specific details need not be employed to practice the present invention. Conversely, specific details known to the person skilled in the art are omitted for the purposes of clarity where appropriate.

In embodiments of the present description, a method (or system/apparatus) for training and using generalized imitation learning models is provided.

Whilst the method is described for the purposes of controlling a videogame, it will be appreciated that it is not limited to this purpose, and is also applicable to learning any computer-controlled action in response to a given circumstance, such as autonomous navigation, sorting, ordering, and/or positioning of objects, responding to user behavior (e.g. in a UI or caring scenario), or the like.

Broadly summarized, the method clusters together similar videos and/or state-sequences (for example of expert demonstrations) based on similarity, and by aligning the states with actions through a so-called joint embedding (described later herein), implements a loss function that penalizes actions based on how inappropriate they are for the cluster of states the target sample falls within.

The advantage of such an approach versus a normal behavioral cloning approach through imitation learning is that it is aimed at teaching a network what actions are appropriate given a circumstance represented by a cluster of states, rather than simply to copy exactly what an expert did in a single instance. Furthermore, training with such an approach should also converge faster and have a higher ability to play a game (or other function, as outlined earlier), as multiple samples from similar states, with different actions, will no longer have opposing effects on the loss function used in training.

In the example of playing a videogame, a state sequence may comprise one or more selected from the list consisting of:
A video;
A series of images ordered chronologically from the game (RGB, depth, segmentation, etc.);
A set of telemetry data from in-engine (distance to characters, objects, etc.);
A state matrix from the game;
Any other suitable parametric game state representation; and
A vector representing the state following a dimensionality reduction.

In the case of video or images, optionally these can be pre-processed, for example to remove color and normalize for brightness, reduce resolution, and/or remove extraneous elements (e.g. crop to remove any heads-up overlay, or to crop the outer N % of the image, or to only retain the inner M % of an image around a predetermined feature such as an in-game player avatar, or the like).

It will be appreciated that for other uses, other state sequences may be appropriate. For example for autonomous navigation it may comprise some or all of video, LIDAR, GPS, Steering, and Engine/Gearbox/Brake status information.

The state or state sequence input should adequately represent the current situation in the game. The current situation should preferably comprise that area of the game able to currently influence, or be influenced by, the player of the game or their in-game avatar. It may not be necessary to represent the full current state of the game for this purpose. Hence for example the state may relate to physically proximate elements of the game to the player, and if in a sequence, temporally proximate state data (e.g. data for one or more moments preceding the current state, as well as the current state).

In the example of playing a videogame, an action or action sequence may comprise one or more selected from the list consisting of:
A controller input or user gesture;
A sequence of controller inputs or user gestures over time;
A language-based instruction (e.g. a string variable);
In-game state updates (vector representing movement, instruction that character should jump etc.)—i.e. the game's internal interpretation of the action or actions; and

A vector representing the action following a dimensionality reduction.

Again, other uses may have their own characteristic actions (e.g. steering, acceleration and braking in the case of autonomous driving), and be represented appropriately using one or more of the above or other forms.

The action or action sequence should be meaningful or consequential, which is to say that the desired future behavior of a controlled object (e.g. the player's character) can in principle be inferred from it.

Typically but optionally, the action sequence is offset in time by a small amount from the state sequence, such as 150 ms as a standard human reaction time. This enables a realistic prediction of what actions an IL agent should take based on the state sequence using machine learning as described elsewhere herein.

In the case of both the state and action representations, different states/actions should produce different representations if they are materially different within the context of the game/application. Meanwhile if they are similar, then the representations should also be similar. How this is achieved is discussed below.

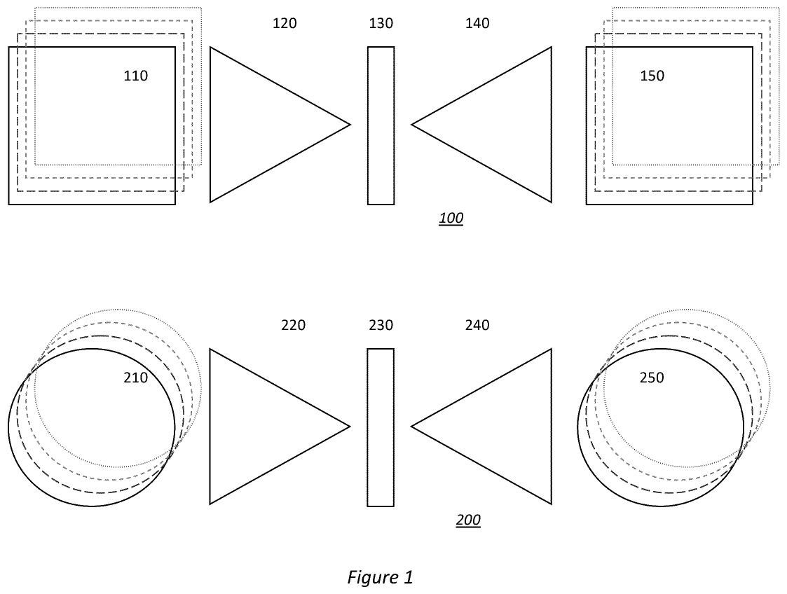

Referring now to the drawings, wherein like reference numerals designate identical or corresponding parts throughout the several views, FIG. 1 shows two autoencoder systems (100, 200).

State autoencoder 100 takes as an input a state sequence 110 (denoted by multiple squares), or a single state snapshot if historical information is not required, and trains a machine learning network (120, 130, 140) to generate as an output 150 a close approximation of the input. The initial layer or layers 120 of the network serve to reduce the dimensionality of the input, to a predetermined dimensionality represented by an interim layer 130. The later layer or layers 140 of the network effectively treat the interim layer 130 as an input to be enhanced in order to reconstruct the original input 110.

Normally, once trained to provide a satisfactory reconstruction, such a network is clamped (i.e. stops learning) and is only subsequently used in inference mode with the initial layer(s) 120 used as the encoder typically in a transmitter device, the generated values at the interim layer (130) acting as the encoded data, and the later layer(s) 140 acting as the decoder typically in a receiver device.

As will be explained later herein, embodiments of the present description do not follow this approach.

Action autoencoder 200 operates in essentially the same way as the state autoencoder above, taking as an input an action sequence 210 (denoted by multiple squares), or a single action/action set if historical information is not required, and trains a machine learning network (220, 230, 240) to generate as an output 250 a close approximation of the input. The initial layer or layers 220 of the network serve to reduce the dimensionality of the input, to a predetermined dimensionality represented by an interim layer 230. The later layer or layers 240 of the network effectively treat the interim layer 230 as an input to enhance in order to reconstruct the original input 210.

Typically the encoder part of each network (120, 220) will be a transformer, to account for the temporal nature of the data (if used), and compresses the input down onto a lower dimensional representation in its final layer (the interim layer (130, 230).

Again, normally such a network is clamped and used for encoding transmissions, but embodiments of the present description do not follow this approach.

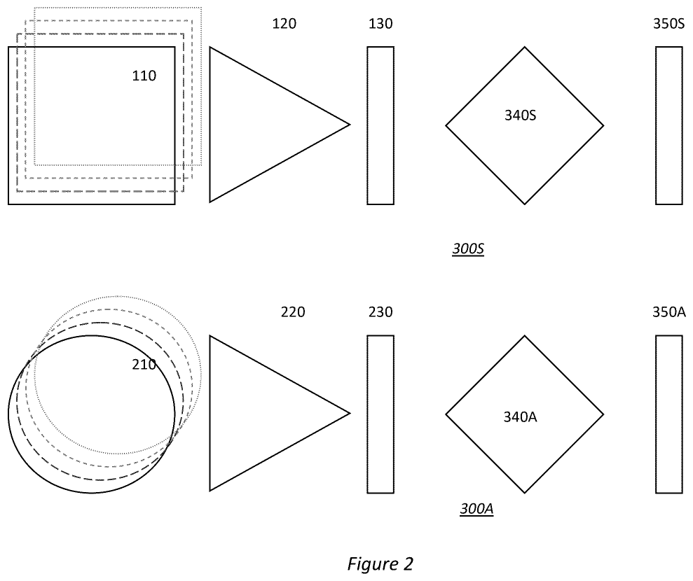

Instead, referring now to FIG. 2, the first half of the trained state autoencoder 100, and the first half of the trained action autoencoder 200, in each case up to the generated interim layer (130, 230), are used in their clamped/inference form to consistently generate their respective encoded representations (130, 230). These representations at the interim layer are meaningful, in the sense of being capable of distinguishing states and actions that have consequence in the game (and hence enabling reconstruction, if this was being performed).

However, these are then used as input to a respective new machine learning system 340S,A to generate a new respective output 350S,A to form respective new systems 300S,A as described below.

It will be appreciated that the two auto encoders (120, 220), trained separately on quite different input and target data, will generate significantly different interim representations/encodings of their respective data at the interim layers (130, 230). This may for example be in terms of the density and distribution of information within their respective latent spaces, so that there is no simple correlation between the representations of actions and the representation of states.

Accordingly the new ML systems 340S,A are trained to output new representations 350S,A, based on different cost metrics, using the consistent but independent outputs of the interim layers (130, 230) as respective inputs. Hence these ML systems may be referred to as decoders, but because they do not reconstruct the original input like decoders 140, 240, may instead be referred to as recoders because they take the current encoding and produce a new encoding.

Hence a recoder is an ML system (e.g. a neural network) that transforms (or recodes) the encoded input into a differently encoded output (based on the training scheme herein), rather than attempting to reconstruct the original data from the encoded input.

Notably, in the training scheme for the recoders, they can each be trained with a triplet loss function.

For the state representation 350S, the loss values or error values are combined to form the loss function used to train the state recoder 340S.

### These are

Loss_1: minimize (state_pos1−state_pos2)
Loss_2: maximize (state_pos1−state_neg1)
Loss_3: minimize (state_pos1−action_pos1)

The terms are described in more detail later herein.

For the action representation 350A, similarly the loss values or error values are combined to form the loss function used to train the state recoder 340A.

### These are

Loss_1: minimize (action_pos1−action_pos2)
Loss_2: maximize (action_pos1−action_neg1)
Loss_3: minimize (state_pos1−action_pos1)

Hence it will be appreciated that in each case Loss_1 and Loss_2 follow similar formats, whilst Loss_3 is effectively identical (or could be reversed, e.g. (action_pos1−state_pos1), or equivalently the absolute value in either case).

The terms are as follows.
The ‘pos1’ suffix represents the current input to the system (i.e. the current state or action, as appropriate).
The ‘pos2’ suffix represent a similar state/action, as appropriate.
A similar state/action can be sourced using any suitable technique, including but not limited to:
   i. Assuming that a state/action within a predetermined time/frame count from the current input is representative of the same state/action, and so can form a similar pair; and/or
   ii. Retrieving a similar state/action pair from the training dataset (for example as identified by manual tagging, or by comparing other metrics relating to the action and state).
The ‘_neg1’ suffix represents a negative example; that is to say, a state/action dissimilar to the current input. This dissimilar example can be sourced using any suitable technique, including but not limited to:
   i. Assuming that a state/action randomly selected from the training set is dissimilar to the current input
      Optionally selected from outside a predetermined time/frame count from the current input, and/or
      Optionally checked for difference based on other metrics relating to the action or state; and
   ii. Using manual tagging of the state/action data.

Hence in each case, the state recoder seeks to minimize representational differences for similar states, maximize representational differences for dissimilar states, and also minimize representational differences between corresponding states and actions (i.e. between parallel, corresponding, inputs to the two recoders).

Meanwhile the action recoder seeks to minimize representational differences for similar actions, maximize representational differences for dissimilar actions, and again also minimize representational differences between corresponding states and actions (i.e. between parallel, corresponding, inputs to the two recoders).

Thus both recoders are trying to achieve similarity for similar inputs as well as discrimination between distinct inputs, and at the same time are trying to provide similar outputs to each other (thereby overcoming the issue that the original representations 130, 230 from the autoencoders 100, 200 are arbitrarily different)

The overall effect is thus a convergence of representations 350S,A for similar state/action pairs whilst exhibiting good discrimination between distinct state/action pairs.

The losses for training each recoder can be combined by being applied after being summed (equivalent to being applied in parallel) or by being applied in sequence, in either case using the training algorithm appropriate to the network.

Other triplet loss functions adhering to this basic principle of simultaneously discriminating representations for different respective inputs whilst converging representations for parallel current inputs can be considered. In general, the use of any suitable contrastive loss functions in the above triplet formulation will work.

In effect, the above approach serves to translate the internal representations of the autoencoder layers 130, 230 into a common representation at layers 350S,A. taking this one step further back, the above approach thus also serves to translate the game states and action inputs into a common representation at layers 350S,A that remain meaningful, which is to say that they serve to discriminate between different states and between different actions.

The two systems 300S,A can thus be referred to as a converged state encoder and a converged action encoder, respectively.

As explained later herein, these trained converged encoders will then be used to train the actions of an imitation learning system, in a manner that improves its flexibility (and typically shortens the training time).

As noted previously herein, imitation learning systems normally use behavioral cloning, where a specific action is presented in response to a specific game state/circumstance, and hence the system tries to imitate exactly what an expert did in that single instance.

However, this has the disadvantage that similar states that have multiple valid actions have opposing effects on the loss function. Hence for example if fighting a boss, it may be equally valid to hold a sword in a blocking position or hold a shield in a blocking position. More generally where learning is per example, if the specific example of an action is to go left, and the machine elects to go right, it gets penalized even if going right is an acceptable option more generally. A traditional imitation learning system will either conclude that these two actions are wrong, with respect to each other, or try to determine a (non-existent) difference in the game state that distinguishes them.

Accordingly, in embodiments of the present description, two possible training schemes may be considered for use with any suitable imitation learning system to achieve an improved result.

In the first approach, at runtime the imitation learning system is presented with a game state and attempts an action in response. Typically, the game state is one from the training set already established as described previously.

The action proposed by the imitation learning system is then run through the converged action encoder to generate a representation 350A of the proposed action.

The appropriateness of the action proposed by the imitation learning system (i.e. the loss function for training the imitation learning system) is then responsive to the distance (e.g. vector distance) between the representation 350A of the proposed action and the representation 350S of the presented game state.

Because the creation of the action and state representations is based on training decodes 340S,A to generate converged representations, the correspondence between the two representations 350S and 350A tends to be a function of the frequency of co-occurrence and the strength of correlation between the state and action; hence for example if turning left or right are equally valid choices, then they will typically be equally similar to the state representation. Meanwhile if turning right is 10× more frequent than turning left, then turning right is likely to be more similar to the state representation than turning left, but both will be more similar to the state representation than, for example, an inappropriate action in the situation, like firing a weapon.

In this way the imitation learning algorithm develops a model of what are reasonable actions based on these similarities, rather than learning based on inconsistent per-example feedback where (to re-use the example above) turning left is ‘wrong’, except for 10% of the time when it is ‘right’, for the same situation.

In a second approach, scene representations and optionally action representations of the training set are clustered (e.g. using k-means clustering, or any suitable algorithm).

Then during training of the imitation learning system, the proposed output can be evaluated as a function of its distance from the center of the corresponding scene cluster, or optionally as a function of its distance from the center of an action cluster that corresponds to the scene cluster in the training set.

This approach further reduces individual example difference variability (i.e. more tolerance to different valid options in a situation). It also allows for tuning of training by adjusting the loss function between clusters, if some are considered more important than others. Finally, it can also allow for control of scene/action classification based on the number of clusters that are allowed for form.

As such, this approach is more tolerant of diverse actions, and more tunable, than the first approach.

It will be appreciated that in both cases, it is assumed that the examples in the training set are good examples—i.e. the actions in response to a given situation are reasonable, and preferably good. Hence typically the examples within the dataset may be those of one or more expert players.

Hence whether trained using the first or second approach, the imitation learning system is trained using a loss function determined based on differences in outputs of a separate pair of machine learning systems, those machine learning systems having been trained to generate convergent representations for states and corresponding actions, respectively. The separate pair of trained machine learning systems take the current state and the imitation learning system's proposed action and generate their respective representations of these. The difference between the imitation learning system's proposed action, and the collective reasonable actions for that game state within the training set, will then be reflected in the degree of difference between the resulting representations of the state and the proposed action. This degree of difference can then be used as the basis for a loss function to train the imitation learning system, optionally weighted by the class of state and/or action concerned.

As noted previously herein, an advantage of this versus a normal behavioral cloning approach is that it is aimed at teaching a network what actions are appropriate given a circumstance, rather than simply to copy exactly what an expert did in a single instance. The imitation learning system should as a result also converge faster and have an improved ability to play the game (or more generally respond to circumstance) as multiple samples from similar states, with different actions, will no longer have opposing effects on the loss function.

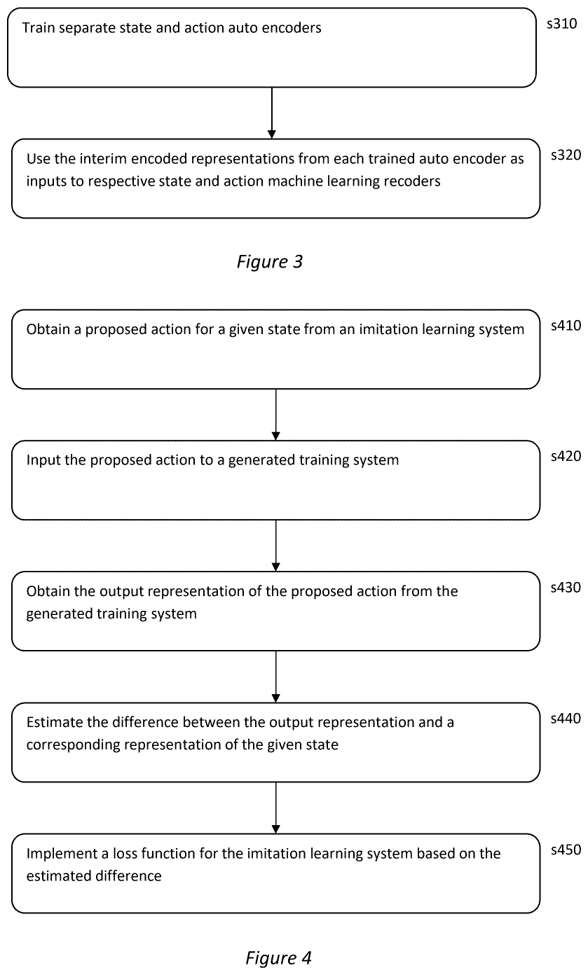

Referring now to FIG. 3, in a summary embodiment of the present description a method of generating a training system comprises the following steps.
For a set of states and corresponding actions,
Firstly, in step s310, training separate state and action auto encoders, as described elsewhere herein.
Secondly in step s320, using the interim encoded representations from each trained auto encoder as input to a respective state machine learning recoder and action machine learning recoder, as described elsewhere herein.

Wherein, each of the state and action recoders are trained with a respective multi-part loss function that simultaneously discriminates output representations for different respective inputs within each recoder whilst converging representations for parallel current state and action inputs between the recoders, as described elsewhere herein.

In this way, a training system is generated that seeks to output meaningful representations of states and actions, in which the representations for corresponding states and actions are similar, whilst the representations between different states, and the representations between different actions, are dissimilar.

It will be apparent to a person skilled in the art that variations in the above method corresponding to operation of the various embodiments of the apparatus as described and claimed herein are considered within the scope of the present invention, including but not limited to that:
the multipart loss function for each recoder comprises a first loss seeking to minimize differences between outputs for similar inputs; a second loss seeking to maximize differences between outputs for different inputs; and a third loss seeking to minimize differences between outputs from both recoders for parallel inputs, as described elsewhere herein;
   in this case, optionally the multipart loss function for the state recorder comprises a first loss seeking to minimize a difference between outputs for similar states; a second loss seeking to maximize a difference between outputs for different states; and a third loss seeking to minimize a difference between the output of the action recorder and the state recorder for corresponding action and state inputs, as described elsewhere herein; and
   similarly in this case, optionally the multipart loss function for the action recorder comprises a first loss seeking to minimize a difference between outputs for similar actions; a second loss seeking to maximize a difference between outputs for different actions; and a third loss seeking to minimize a difference between the output of the state recorder and the action recorder for corresponding state and action inputs, as described elsewhere herein.

Referring now to FIG. 4, in a summary embodiment of the present description a method of generating a trained imitation learning system comprises the following steps.
For a set of states and corresponding actions,
In a first step s410, obtaining a proposed action for a given state from the imitation learning system, as described elsewhere herein.
In a second step s420, inputting the proposed action to a training system generated according to the method above, e.g. as per steps s310 and s320, and/or as described elsewhere herein;
In a third step s430, obtaining the output representation of the proposed action from the generated training system, as described elsewhere herein;
In a fourth step s440, estimating the difference between the output representation and a corresponding representation of the given state (for example generated by the training system, or optionally previously generated in the case that the state is from an existing training set), as described elsewhere herein; and
In a fifth step s450, implementing a loss function for the imitation learning system based on the estimated difference.

In this way, an imitation learning system is trained to learn actions are appropriate given a circumstance, rather than simply to copy exactly what an expert did in a single instance. This improves the generality of the imitation learning system and its ability to respond to given states with appropriate actions.

It will be apparent to a person skilled in the art that variations in the above method corresponding to operation of the various embodiments of the apparatus as described and claimed herein are considered within the scope of the present invention, including but not limited to that:
the step of estimating the difference comprises estimating the difference between the output representation and a representation derived from a cluster comprising the corresponding representation of the given state, as described elsewhere herein; and
in this case, optionally the step of implementing a loss function comprises adjusting the loss function based upon which cluster the corresponding representation of the given state belongs to, as described elsewhere herein.

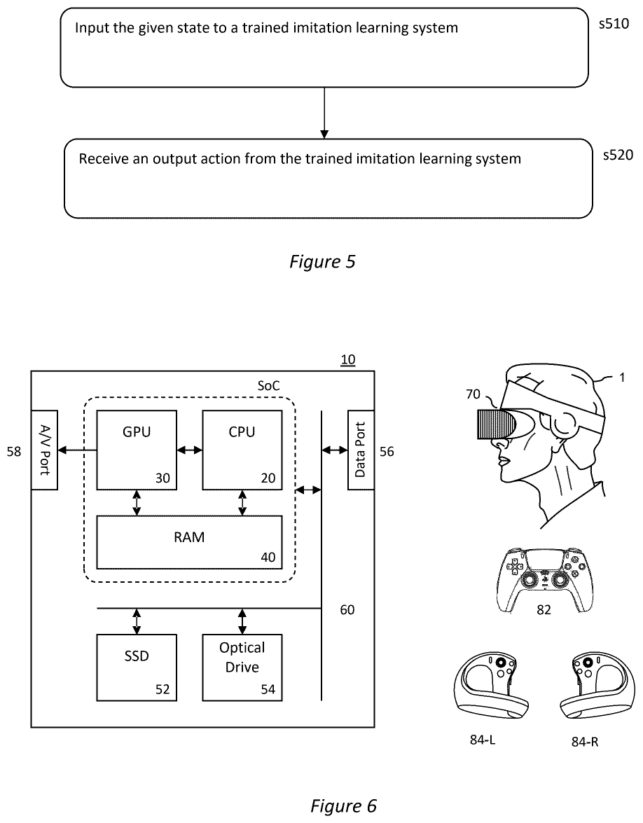

Referring now to FIG. 5, in a summary embodiment of the present description a method of automatically generating an action in response to an input state comprises the following steps.
For a given state,
In a first step s510, inputting the given state to a trained imitation learning system generated according to the method above, i.e. steps s410-s450, and/or as described elsewhere herein.
In a second step s520, receiving an output action from the trained imitation learning system.

It will be apparent to a person skilled in the art that variations in the above method corresponding to operation of the various embodiments of the apparatus as described and claimed herein are considered within the scope of the present invention, including but not limited to that:
the method comprises the further step of implementing the output action, as described elsewhere herein.
the given state relates to one selected from the list consisting of a videogame, autonomous navigation in the real world (e.g. an autonomous robot or car), the arrangement of objects in the real world (e.g. moving, stacking, sorting, assembling, or otherwise manipulating objects), and a condition of one or more users (e.g. in a UI or care environment, or elsewhere), as described elsewhere herein.

It will be appreciated that the above methods may be carried out on hardware suitably adapted as applicable by software instruction or by the inclusion or substitution of dedicated hardware. The hardware for each method may be separate, or the same.

Thus the required adaptation to existing parts of an equivalent device may be implemented in the form of a computer program product comprising processor implementable instructions stored on a non-transitory machine-readable medium such as a floppy disk, optical disk, hard disk, solid state disk, PROM, RAM, flash memory or any combination of these or other storage media, or realized in hardware as an ASIC (application specific integrated circuit) or an FPGA (field programmable gate array) or other configurable circuit suitable to use in adapting the conventional equivalent device. Separately, such a computer program may be transmitted via data signals on a network such as an Ethernet, a wireless network, the Internet, or any combination of these or other networks.

Referring to FIG. 6, an example of such hardware is an entertainment system 10 such a computer or videogame console.

The entertainment system 10 comprises a central processor or CPU 20. The entertainment system also comprises a graphical processing unit or GPU 30, and RAM 40. Two or more of the CPU, GPU, and RAM may be integrated as a system on a chip (SoC). Further storage may be provided by a disk 52. The entertainment device may transmit or receive data via one or more data ports 56. It may also optionally receive data via an optical drive 54. Audio/visual outputs from the entertainment device are typically provided through one or more A/V ports 58 or one or more of the data ports 56. Where components are not integrated, they may be connected as appropriate either by a dedicated data link or via a bus 60.

An example of a device for displaying images output by the entertainment system is a head mounted display ‘HMD’ 70, worn by a user 1. Interaction with the system is typically provided using one or more handheld controllers 82, and/or one or more VR controllers (84-L,R) in the case of the HMD.

Accordingly, in a summary embodiment of the present description, a training system generator (for example entertainment device 10, or a development kit thereof, or similarly a PC or cloud computing platform), comprises the following.

A processor (e.g. CPU 20), configured (for example by suitable software instruction) to carry out the steps of, for a set of states and corresponding actions: training separate state and action auto encoders; using the interim encoded representations from each trained auto encoder as input to a respective state and action machine learning recoder; and wherein each of the state and action recoders are trained with a respective multi-part loss function that simultaneously discriminates output representations for different respective inputs within each recoder whilst converging representations for parallel current state and action inputs between the recoders, as described elsewhere herein.

Instances of this summary embodiment implementing the methods and techniques described herein (for example by use of suitable software instruction) are envisaged within the scope of the application.

Similarly, in a summary embodiment of the present description, an imitation learning system generator (for example entertainment device 10, or a development kit thereof, or similarly a PC or cloud computing platform), comprises the following.

A processor (e.g. CPU 20), configured (for example by suitable software instruction) to carry out the steps of, for a set of states and corresponding actions: obtaining a proposed action for a given state from the imitation learning system; inputting the proposed action to a training system generated by the training system generator referred to elsewhere herein; obtaining the output representation of the proposed action from the generated training system; estimating the difference between the output representation and a corresponding representation of the given state; and implementing a loss function for the imitation learning system based on the estimated difference, thereby training the imitation learning system.

Instances of this summary embodiment implementing the methods and techniques described herein (for example by use of suitable software instruction) are envisaged within the scope of the application.

Similarly, in a summary embodiment of the present description, action generator (for example entertainment device 10, or a development kit thereof, or similarly a PC or cloud computing platform), configured (for example by suitable software instruction) to automatically generate an action in response to an input state, comprises the following.

A processor (e.g. CPU 20), configured (for example by suitable software instruction) to carry out the steps of, for a given state: inputting the given state to an imitation learning system trained according to the method referred to elsewhere herein; and receiving an output action from the trained imitation learning system.

Instances of this summary embodiment implementing the methods and techniques described herein (for example by use of suitable software instruction) are envisaged within the scope of the application.

Finally, it will be appreciated that such an action generator may be utilized by any suitable device implementing a function such as playing a videogame, autonomous navigation in the real world, the arrangement of objects in the real world, and a condition of one or more users, as described elsewhere herein.

Hence in a summary embodiment of the present description, an entertainment device or similar comprises such an action generator, configured to automatically generate an action in response to input of a generated game state; and an input processor (e.g. CPU 20) configured (for example by use of suitable software instruction) to input the automatically generated action to the videogame.

Again, instances of this summary embodiment implementing the methods and techniques described herein (for example by use of suitable software instruction) are envisaged within the scope of the application.

The foregoing discussion discloses and describes merely exemplary embodiments of the present invention. As will be understood by those skilled in the art, the present invention may be embodied in other specific forms without departing from the spirit or essential characteristics thereof. Accordingly, the disclosure of the present invention is intended to be illustrative, but not limiting of the scope of the invention, as well as other claims. The disclosure, including any readily discernible variants of the teachings herein, defines, in part, the scope of the foregoing claim terminology such that no inventive subject matter is dedicated to the public.

What is claimed is:

1. A method of generating a training system, comprising the steps of:
for a set of states and corresponding actions,
training separate state and action auto encoders; and
using interim encoded representations from each trained auto encoder as input to a respective state and action machine learning recoder;
wherein each of the state and action recoders are trained with a respective multi-part loss function that simultaneously discriminates output representations for different respective inputs within each recoder whilst converging representations for parallel current state and action inputs between the recoders.

2. The method of claim 1, in which the multi-part loss function for each recoder comprises:
a first loss seeking to minimize differences between outputs for similar inputs;
a second loss seeking to maximize differences between outputs for different inputs; and
a third loss seeking to minimize differences between outputs from both recoders for parallel inputs.

3. The method of claim 2, in which the multi-part loss function for the state recorder comprises
a first loss seeking to minimize a difference between outputs for similar states;
a second loss seeking to maximize a difference between outputs for different states; and
a third loss seeking to minimize a difference between the output of the action recorder and the state recorder for corresponding action and state inputs.

4. The method of claim 2, in which the multi-part loss function for the action recorder comprises
a first loss seeking to minimize a difference between outputs for similar actions;
a second loss seeking to maximize a difference between outputs for different actions; and
a third loss seeking to minimize a difference between the output of the state recorder and the action recorder for corresponding state and action inputs.

5. The method of claim 1, in which:
obtaining a proposed action for a given state from an imitation learning system;
inputting the proposed action to the training system;
obtaining the output representation of the proposed action from the generated training system;
estimating the difference between the output representation and a corresponding representation of the given state; and
implementing a loss function for the imitation learning system based on the estimated difference.

6. The method of claim 5, in which:
the step of estimating the difference comprises estimating the difference between the output representation and a representation derived from a cluster comprising the corresponding representation of the given state.

7. The method of claim 6, in which:
the step of implementing a loss function comprises adjusting the loss function based upon which cluster the corresponding representation of the given state belongs to.

8. The method of claim 5, in which:
for a given state:
inputting the given state to the trained imitation learning system; and
receiving an output action from the trained imitation learning system.

9. The method of claim 8, comprising the step of:
implementing the output action.

10. The method of claim 8, in which the given state relates to one selected from a list consisting of:
i. a videogame;
ii. real-world autonomous navigation;
iii. a real-world arrangement of objects; and
iv. a condition of one or more users.

11. The method of claim 5, further comprising the steps of:
generating game states of a videogame;
automatically generating, by the action generator, an action in response to input of a generated game state; and
inputting the automatically generated action to the videogame.

12. A non-transitory, computer readable storage medium containing a computer program comprising computer executable instructions that when executed by a computer system, cause the computer system to perform a method of generating a training system, comprising the steps of:
for a set of states and corresponding actions,
training separate state and action auto encoders; and
using interim encoded representations from each trained auto encoder as input to a respective state and action machine learning recoder;
wherein each of the state and action recoders are trained with a respective multi-part loss function that simultaneously discriminates output representations for different respective inputs within each recoder whilst converging representations for parallel current state and action inputs between the recoders.

13. A system, comprising:
a processor, configured to carry out the steps of a training system generator:
for a set of states and corresponding actions,
training separate state and action auto encoders; and
using interim encoded representations from each trained auto encoder as input to a respective state and action machine learning recoder; and
wherein each of the state and action recoders are trained with a respective multi-part loss function that simultaneously discriminates output representations for different respective inputs within each recoder whilst converging representations for parallel current state and action inputs between the recoders.

14. The system of claim 13, wherein the processor or an additional processor is further configured to carry out the steps of an imitation learning system:
for a set of states and corresponding actions,
obtaining a proposed action for a given state from the imitation learning system;
inputting the proposed action to a training system generated by the training system generator;
obtaining the output representation of the proposed action from the generated training system;
estimating the difference between the output representation and a corresponding representation of the given state; and
implementing a loss function for the imitation learning system based on the estimated difference.
